(19) United States
(12) Patent Application Publication
(10) Pub. No.: US 2008/0155552 A1
(43) Pub. Date: Jun. 26, 2008

(54) SERVER, CLIENT, LOAD BALANCING SYSTEM AND LOAD BALANCING METHOD THEREOF

(75) Inventor: Sung Kim, Incheon (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/751,129

(22) Filed: May 21, 2007

(30) Foreign Application Priority Data
Dec. 20, 2006 (KR) 2006-130831

(51) Int. Cl. G06F 9/46

(52) U.S. Cl. 718/105

(57) ABSTRACT

A server, a client, a load balancing system and a load balancing method thereof, the load balancing system including a plurality of servers to process network traffic; and a client to transmit a connection request signal to each of the plurality of servers, and to connect to a server transmitting a first received response signal if a response signal corresponding to the connection request signal is received from at least one server from among the plurality of servers. Therefore, traffic load can be efficiently distributed without a separate load balancer.

### CROSS-REFERENCE TO RELATED APPLICATION

This application claims the benefit of Korean Patent Application No. 2006-130831, filed Dec. 20, 2006 in the Korean Intellectual Property Office, the disclosure of which is incorporated herein by reference.

### BACKGROUND OF THE INVENTION

1. Field of the Invention

Aspects of the present invention relate to a server, a client, a load balancing system, and a load balancing method thereof, and more particularly, to a server, a client, a load balancing system, and a load balancing method thereof in which a traffic load can be efficiently distributed.

2. Description of the Related Art

FIG. 1 is a block diagram of a conventional load balancing system 100. As shown in FIG. 1, a load balancing system 100 includes a plurality of clients 10-1, 10-2, . . . , 10-N, a load balancer 20, and a plurality of servers 30-1, 30-2, 30-3, . . . , 30-N.

The load balancing system 100 registers the plurality of servers 30-1, 30-2, 30-3, . . . , 30-N with the load balancer 20, and periodically prepares a load level table. Load information of the plurality of servers 30-1, 30-2, 30-3, . . . , 30-N is collected in the load level table in order for the load balancing system 100 to adjust the load levels. Servers with the same level are selected from among servers with a regular load level or lower by a round robin method to perform load balancing.

In other words, when selecting a server in response to a connection request from the plurality of clients 10-1, 10-2, . . . , 10-N, the load balancer 20 selects a server with the lowest load level from among the plurality of servers 30-1, 30-2, 30-3, . . . , 30-N using a round robin method. In order to do so, each of the plurality of servers 30-1, 30-2, 30-3, . . . , 30-N transmits their respective load information to the load balancer 20, and monitor the load state periodically. If the load state changes, the servers 30-1, 30-2, 30-3, . . . , 30-N may inform the load balancer 20 of this changed state.

Additionally, the load balancer 20 may adjust the load level for the load state of the plurality of servers 30-1, 30-2, 30-3, . . . , 30-N, and select the server with the lowest load level in response to a connection request from the plurality of clients 10-1, 10-2, . . . , 10-N.

The conventional load balancing system 100 performs load balancing using the load balancer 20. As a result, an additional cost may be charged for purchasing the load balancer 20. In addition, since the load balancer 20 must periodically collect the load states of the plurality of servers 30-1, 30-2, 30-3, . . . , 30-N, the monitoring period of the servers 30-1, 30-2, 30-3, . . . , 30-N should be reduced in order to reflect the load state of servers that are dynamically changed. If it is impossible to reduce the period, it is difficult to accurately reflect the load states of the servers 30-1, 30-2, 30-3, . . . 30-N.

Furthermore, if the client excessively requests a connection, the load may be concentrated on the load balancer 20. Accordingly, if the load balancer 20 goes down, load balancing cannot be performed.

### SUMMARY OF THE INVENTION

Aspects of the present invention relate to a server, a client, a load balancing system, and a load balancing method thereof in which a traffic load can be efficiently distributed.

According to an aspect of the present invention, there is provided a load balancing system including: a plurality of servers to process network traffic; and a client to transmit a connection request signal to each of the plurality of servers, and to connect to a server transmitting a first received response signal if a response signal corresponding to the connection request signal is received from at least one server from among the plurality of servers.

According to an aspect of the invention, each of the plurality of servers may compute a delay time based on a load state of the server and transmit the response signal to the client after the computed delay time has elapsed.

According to an aspect of the invention, each of the plurality of servers may compute the delay time according to:

$$DT = \frac{{\sum }_{i = 1}^{LC} LTi \times LWi}{LC} \times MT$$

where DT indicates the delay time, LT indicates an amount of server load, LC indicates a number of items used to measure the server load, LW indicates a weighting of the items used to measure the server load, and MT indicates a maximum response time.

According to another aspect of the invention, there is provided a client of a load balancing system including a plurality of servers, the client including: a network interface to transmit signals to and receive signals from the plurality of servers; and a controller to transmit connection request signals to the plurality of servers, and to connect to a server transmitting a first received response signal if response signals corresponding to the connection request signals are received.

According to another aspect of the invention, there is provided a server of a load balancing system including a client, the server including: a network interface to transmit signals to and receive signals from the client; a computing unit to compute a delay time based on a load state of the server; and a controller to transmit the response signal corresponding to a connection request signal to the client after the computed delay time has elapsed if the connection request signal is received from the client.

According to an aspect of the invention, the computing unit may compute the delay time according to:

$$DT = \frac{{\sum }_{i = 1}^{LC} LTi \times LWi}{LC} \times MT$$

where DT indicates the delay time, LT indicates an amount of server load, LC indicates a number of items used to measure the server load, LW indicates a weighting of the items, and MT indicates a maximum response time.

According to another aspect of the present invention, there is provided a load balancing method including: transmitting connection request signals to a plurality of servers from a client; transmitting response signals corresponding to the connection request signals to the client from each of the plurality of servers; and receiving the response signals from the plurality of servers and connecting to a server transmitting a first response signal received first from among the received response signals.

According to another aspect of the invention, the transmitting of the response signals includes: computing a delay time for each of the plurality of servers based on a load state of each server; and transmitting the response signal to the client after the computed delay time has elapsed.

According to another aspect of the invention, each of the plurality of servers may compute the delay time according to:

$$DT = \frac{{\sum }_{i = 1}^{LC} LTi \times LWi}{LC} \times MT$$

where DT indicates the delay time, LT indicates an amount of server load, LC indicates a number of items used to measure the server load, LW indicates a weighting of the items, and MT indicates a maximum response time.

According to another aspect of the present invention, there is provided a load balancing method of a client of a load balancing system including a plurality of servers, the method including: transmitting a connection request signal to each of a plurality of servers; receiving response signals corresponding to the connection request signals from the plurality of servers; and connecting to a server transmitting a first received response signal that is received first from among the received response signals.

According to another aspect of the present invention, there is provided a load balancing method of a server of a load balancing system including a client, the method including: receiving a connection request signal from the client; computing a delay time based on a load state of the server; and transmitting a response signal corresponding to the connection request signal to the client after the computed delay time has elapsed.

According to another aspect of the invention, computing of the delay time may include computing the delay time according to:

$$DT = \frac{{\sum }_{i = 1}^{LC} LTi \times LWi}{LC} \times MT$$

where DT indicates the delay time, LT indicates an amount of server load, LC indicates a number of items used to measure the server load, LW indicates a weighting of the items, and MT indicates a maximum response time.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional load balancing system;

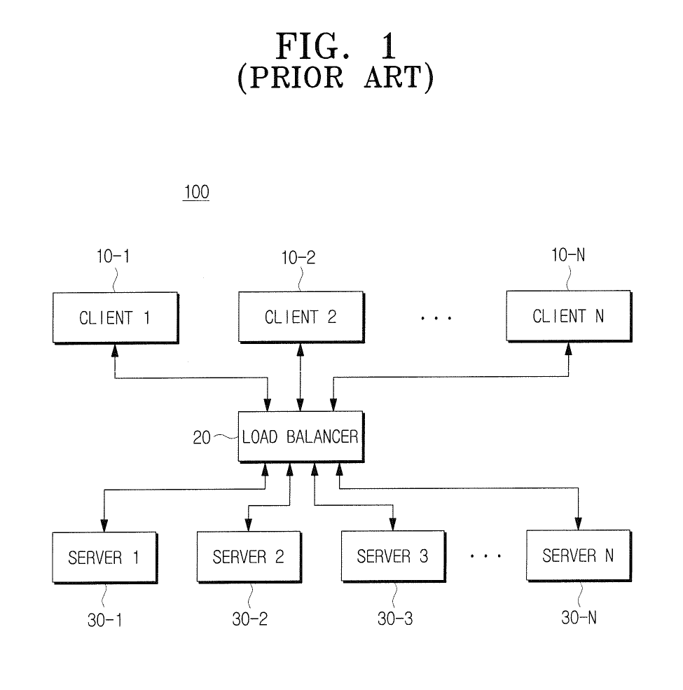

FIG. 2 is a block diagram of a load balancing system according to an embodiment of the present invention;

FIG. 3 is a block diagram of a client according to an embodiment of the present invention;

FIG. 4 is a block diagram of a server according to an embodiment of the present invention; and

FIGS. 5 through 7 are flowcharts explaining a load balancing method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

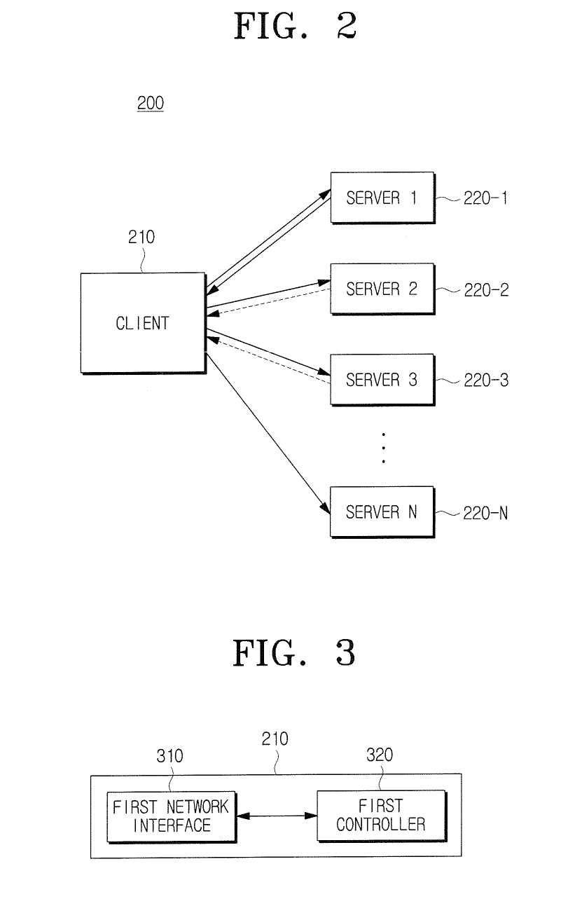

FIG. 2 is a block diagram of a load balancing system 200 according to an embodiment of the present invention. As shown in FIG. 2, the load balancing system 200 includes a client 210 and a plurality of servers 220-1, 220-2, 220-3, . . . , 220-N. The client 210 may be a notebook, a personal computer, a personal digital assistant (PDA), a mobile phone, or any other device that establishes a connection with a plurality of servers 220-1, 220-2, 220-3, . . . , 220-N.

The client 210 may transmit connection request signals to the plurality of servers 220-1, 220-2, 220-3, . . . , 220-N. The client 210 may store a server list (such as a list of Internet Protocol (IP) addresses of the plurality of servers 220-1, 220-2, 220-3, . . . , 220-N) in a storage unit (not shown). Accordingly, the client 210 may transmit the connection request signals to each of the plurality of servers 220-1, 220-2, 220-3, . . . , 220-N.

Additionally, if a plurality of response signals corresponding to the connection request signals is received, the client 210 may connect to the server sending the first received response signal. For example, if response signals are received from a first server 220-1, a second server 220-2, and a third server 220-3 among the plurality of servers 220-1, 220-2, 220-3, . . . , 220-N, the client 210 may connect to the server 1 220-1 transmitting the first received response signal. In other words, since a response signal of a server 220-1 with the lowest load level is received first from among the plurality of servers 220-1, 220-2, 220-3, . . . , 220-N, the client 210 connects to the first server 220-1 transmitting the first received response signal.

The plurality of servers 220-1, 220-2, 220-3, . . . , 220-N process network traffic. Specifically, each of the plurality of servers 220-1, 220-2, 220-3, . . . , 220-N may compute a delay time based on the load state of the server, and transmit the response signals to the client 210 after the computed delay time has elapsed. As a result, the transmission time of the response signal depends on the load state of each of the plurality of servers 220-1, 220-2, 220-3, . . . , 220-N. If it is assumed that the network state is the same (i.e., there are no other variables affecting the transmission time of the response signal), the client 210 may receive the response signal transmitted from the server with the lowest load level first. Accordingly, the load state of the servers 220-1, 220-2, 220-3, . . . , 220-N may be reflected in real time, and the traffic or load may therefore be efficiently distributed.

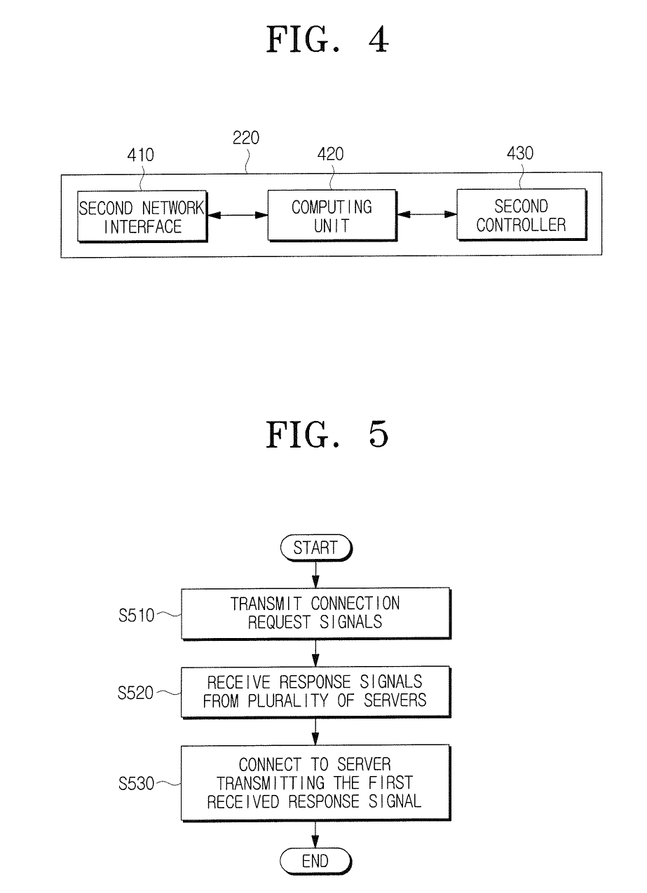

FIG. 3 is a block diagram of a client 210 according to an embodiment of the present invention. As shown in FIG. 3, the client 210 includes a first network interface 310 and a first controller 320.

Referring to FIGS. 2 and 3, the first network interface 310, under the control of the first controller 320, transmits signals to and receives signals from the plurality of servers 220-1, 220-2, 220-3, . . . , 220-N. Specifically, the first network interface 310 may transmit the connection request signals to the plurality of servers 220-1, 220-2, 220-3, . . . , 220-N, and receive the response signals from at least some servers from among the plurality of servers 220-1, 220-2, 220-3, . . . , 220-N.

The first controller 320 controls the entire operation of the client 210. Additionally, the first controller 320 may control the first network interface 310 to transmit the connection request signals to the plurality of servers 220-1, 220-2, 220-3, . . . 220-N.

If a response signal corresponding to a connection request signal is received from at least one server from among the plurality of servers 220-1, 220-2, 220-3, . . . , 220-N through the first network interface 310, the first controller 320 may connect to a server transmitting the first received response signal.

Each response signal from the servers 220-1, 220-2, 220-3, . . . , 220-N is received by the first network interface 310 after each response delay time has elapsed. The response delay time refers to a delay round trip time (DRTT) based on the performance of the servers, and may be computed using the following equation:

DRTT=RTT+DT [Equation 1]

In Equation 1, DRTT indicates the response delay time, RTT indicates the round trip time, and DT indicates the delay time of the server. The response delay time DRRT is based on the delay time DT and the round trip time RTT, which indicates the time required to transmit the connection request signal and the time required to receive the response signal. After the response delay time has elapsed, the response signals may be received.

Accordingly, the first controller 320 may receive the response signal of the server with the lowest load level among the plurality of servers 220-1, 220-2, 220-3, . . . , 220-N first. Additionally, the first controller 320 may ignore the response signals received after the first received signal once the first controller 320 connects to the server transmitting the first received response signal.

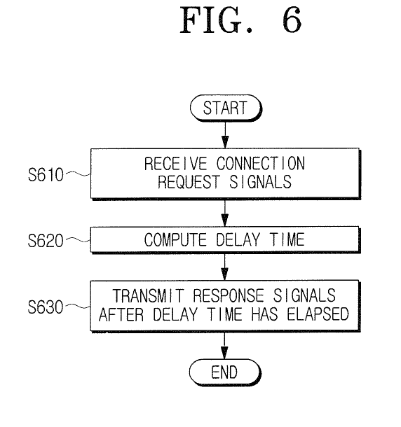

FIG. 4 is a block diagram of a server 220 according to an embodiment of the present invention. As shown in FIG. 4, the server 220 includes a second network interface 410, a computing unit 420, and a second controller 430.

The second network interface 410, under the control of the second controller 430, transmits signals to and receives signals from the client. Specifically, the second network interface 410 may receive the connection request signal from the client, and transmit the response signal to the client.

The computing unit 420 may compute the delay time based on the load state. The load state may be based on the processing capacity of a central processing unit (CPU) (not shown) used and the memory capacity of a memory unit (not shown) used.

For example, the computing unit 420 may compute the delay time by using the following equation:

$$DT = \frac{{\sum }_{i = 1}^{LC} LTi \times LWi}{LC} \times MT \qquad [ Equation 2 ]$$

In Equation 2, DT indicates the delay time, LTi indicates the amount of server load for each item, LC indicates the number of items used to measure the server load, LW indicates the weighting of the server load items, and MT indicates the maximum response time. The amount of server load LTi may be the CPU capacity used and the memory capacity used. That is, if the CPU capacity used and the memory capacity used are measured as the amount of server load, LT1 may be the CPU capacity used, and LT2 may be the memory capacity used.

The delay time may be computed as in the following example. If the LT1 is approximately 50%, the LT2 is approximately 25%, the LW is approximately 1, and the MT (server load sensitivity) is approximately 3 seconds, the DT may be ((0.5*1+0.25*1)/2)*3=1.125 seconds. In other words, the delay time DT of the server 220 is approximately 1.125 seconds.

Accordingly, the delay time DT of the server 220 may be determined according to the amount of server load LT and the maximum response time MT indicating the server load sensitivity. The maximum response time MT indicating the server load sensitivity may depend on the performance of the server, and may be, for example, in the range between approximately 3 seconds and approximately 10 seconds. However, it is understood that the maximum response time MT may be another value, such as an arbitrary value according to the design objectives.

The second controller 430 may control the entire operation of the server 220. Additionally, if the connection request signals are received through the second network interface 410, the second controller 430 may transmit the response signals corresponding to the connection request signals to the client after the delay time computed by the computing unit 420 has elapsed. In other words, after the delay time DT determined according to the load state LT and maximum response time MT has elapsed, the second controller 430 transmits the response signals corresponding to the connection request signals to the client.

The response signals are transmitted based on the load state of each of the plurality of servers, such that the response signal of the server with the lowest load level is transmitted to the client first. The load state of the server dynamically changed is reflected in real time, and thus load balancing may be performed.

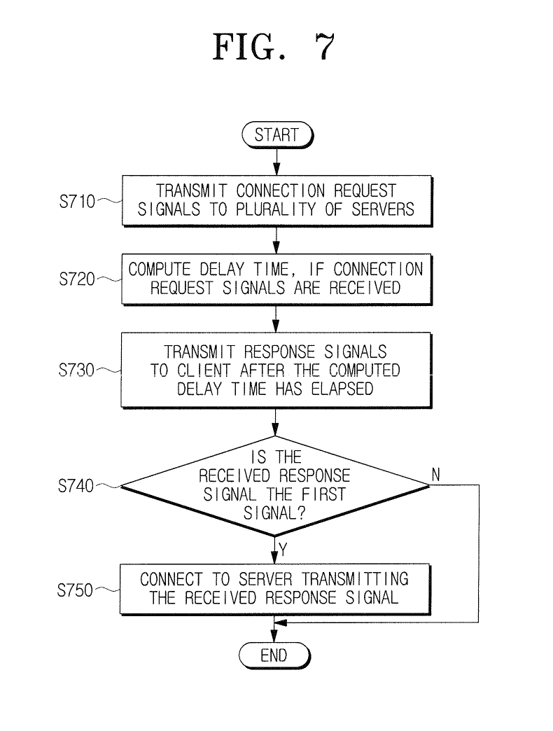

FIGS. 5 through 7 are flowcharts explaining a load balancing method according to an embodiment of the present invention. FIG. 5 is a flowchart explaining a load balancing method of a client according to an embodiment of the present invention. As shown in FIG. 5, the client transmits connection request signals to a plurality of servers in operation S510. The client may transmit the connection request signals to the plurality of servers according to a server list.

If response signals are received from the plurality of servers (operation S530), the client may connect to a server transmitting a response signal received first among the received signals in operation S530. The response signals are received after the response delay time has elapsed. The response delay time refers to a delay round trip time (DRTT) based on the performance of the servers, and may be computed using Equation 1 above. Accordingly, load balancing may be performed based on the network state in addition to the performance of the servers.

FIG. 6 is a flowchart explaining a load balancing method of a server according to an embodiment of the present invention. As shown in FIG. 6, if the connection request signals are received from the client (operation S610), the server may compute the delay time based on the load state of the server in operation S620. The delay time may be computed using Equation 2 above.

The delay time of the server may be determined according to the amount of server load LT and the maximum response time MT indicating the server load sensitivity. The maximum response time MT indicating the server load sensitivity may depend on the performance of the server, and may be, for example, in the range between approximately 3 seconds and approximately 10 seconds. However, it is understood that the maximum response time MT may be another value, such as an arbitrary value according to the design objectives.

After the computed delay time has elapsed, the server transmits the response signals corresponding to the connection request signals to the client in operation S630. Therefore, the load state of the server dynamically changed is reflected in real time, and thus load balancing may be performed.

FIG. 7 is a flowchart explaining a load balancing method according to an embodiment of the present invention. Referring to FIG. 7, the client transmits the connection request signals to the plurality of servers in operation S710. If the connection request signals are received, each of the servers computes the respective delay time in operation S720. The delay time may be computed using Equation 2 above.

After the computed delay time has elapsed, the respective server transmits the response signals corresponding to the connection request signals to the client in operation S730. The client receives the response signals from the plurality of servers. Specifically, the response signals are received after the response delay time has elapsed. The response delay time is based on delay time DT of the server and the round trip time RTT of the server, which indicates the time required to transmit the connection request signal and the time required to receive the response signal. After the response delay time has elapsed, the response signals are received.

The client determines whether the received response signal is the first received signal in operation S740.

If it is determined that the received response signal is the first received signal (operation S740-Y), the client connects to the server transmitting the received response signal in operation S750. If it is determined that the received response signal is not the first received signal (operation S740-N), the client ignores the received response signal.

As described above, according to aspects of the present invention, the traffic load can be efficiently distributed. In addition, it is possible to prevent overload and to dispersively use the plurality of servers without using the load balancer. Furthermore, the client does not attempt to connect to the server without a response from the server.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, optical data storage devices, and a computer data signal embodied in a carrier wave comprising a compression source code segment comprising the code and an encryption source code segment comprising the code (such as data transmission through the Internet). The computer-readable recording medium can also be distributed over network-coupled computer systems so that the computer-readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A load balancing system comprising:
a plurality of servers to process network traffic; and
a client to transmit a connection request signal to each of the plurality of servers, and to connect to one of the servers transmitting a first received response signal if a response signal corresponding to the connection request signal is received from at least one server from among the plurality of servers.

2. The system as claimed in claim 1, wherein each of the plurality of servers computes a delay time based on a load state of the server and transmits the response signal to the client after the computed delay time has elapsed.

3. The system as claimed in claim 2, wherein each of the plurality of servers computes the delay time according to:
$$DT = \frac{{\sum }_{i = 1}^{LC} LTi \times LWi}{LC} \times MT$$
where DT indicates the delay time, LT indicates an amount of server load, LC indicates a number of items used to measure the server load, LW indicates a weighting of the items used to measure the server load, and MT indicates a maximum response time.

4. The system as claimed in claim 3, wherein the amount of the server load, LT, is a central processing unit (CPU) capacity.

5. The system as claimed in claim 3, wherein the amount of the server load, LT, is a memory capacity.

6. The system as claimed in claim 1, wherein the client stores a server list including a list of the plurality of servers in order to transmit the connection request signals to each of the plurality of servers.

7. The system as claimed in claim 6, wherein the server list comprises the Internet Protocol (IP) addresses of the plurality of servers.

8. The system as claimed in claim 1, wherein the client ignores a second received response signal from another one of the servers, received after the first received response signal.

9. A client of a load balancing system including a plurality of servers, the client comprising:
a network interface to transmit connection request signals to and receive response signals from the plurality of servers; and
a controller to control the network interface to transmit the connection request signals to the plurality of servers, and to connect to one of the servers transmitting a first received response signal, if at least one response signal corresponding to the connection request signals is received.

10. The client as claimed in claim 9, wherein the controller controls the network interface to transmit the connection request signals to each of the plurality of servers according to a server list stored by the client.

11. The client as claimed in claim 10, wherein the server list comprises the Internet Protocol (IP) addresses of the plurality of servers.

12. The client as claimed in claim 9, wherein the controller ignores a second received response signal from another one of the servers, received after the first received response signal.

13. A server of a load balancing system including a client, the server comprising:
a network interface to transmit a response signal to and to receive a connection request signal from the client;
a computing unit to compute a delay time based on a load state of the server; and
a controller to transmit the response signal corresponding to the connection request signal to the client after the computed delay time has elapsed if the connection request signal is received from the client.

14. The server as claimed in claim 13, wherein the computing unit computes the delay time according to:
$$DT = \frac{{\sum }_{i = 1}^{LC} LTi \times LWi}{LC} \times MT$$
where DT indicates the delay time, LT indicates an amount of server load, LC indicates a number of items used to measure the server load, LW indicates a weighting of the items, and MT indicates a maximum response time.

15. The server as claimed in claim 14, wherein the amount of the server load, LT, is a central processing unit (CPU) capacity of the server.

16. The server as claimed in claim 14, wherein the amount of the server load, LT, is a memory capacity of the server.

17. A load balancing method comprising:
transmitting a connection request signal to each of a plurality of servers from a client;
transmitting a response signal corresponding to the connection request signal from each of the plurality of servers to the client ; and
receiving the response signals from the plurality of servers and connecting to one of the servers transmitting a first received response signal that is received first from among the received response signals.

18. The method as claimed in claim 17, wherein the transmitting of the response signals comprises:
computing a delay time for each of the plurality of servers based on a load state each server; and
transmitting the response signal to the client after the computed delay time has elapsed.

19. The method as claimed in claim 18, wherein each of the plurality of servers computes the delay time according to:
$$DT = \frac{{\sum }_{i = 1}^{LC} LTi \times LWi}{LC} \times MT$$
where DT indicates the delay time, LT indicates an amount of server load, LC indicates a number of items used to measure the server load, LW indicates a weighting of the items used to measure the server load, and MT indicates a maximum response time.

20. A load balancing method of a client of a load balancing system including a plurality of servers, the method comprising:
transmitting a connection request signal to each of the plurality of servers;
receiving response signals corresponding to the connection request signals from the plurality of servers; and
connecting to one of the servers transmitting a first received response signal that is received first from among the received response signals.

21. A load balancing method of a server of a load balancing system including a client, the method comprising:
receiving a connection request signal from the client;
computing a delay time based on a load state of the server; and
transmitting a response signal corresponding to the connection request signal to the client after the computed delay time has elapsed.

22. The method as claimed in claim 21, wherein the computing of the delay time comprises:
computing the delay time according to:
$$DT = \frac{{\sum }_{i = 1}^{LC} LTi \times LWi}{LC} \times MT$$
where DT indicates the delay time, LT indicates an amount of server load, LC indicates a number of items used to measure the server load, LW indicates a weighting of the items used to measure the server load, and MT indicates a maximum response time.

23. A computer readable recording medium encoded with the method of claim 17 implemented by a computer.

24. A computer readable recording medium encoded with the method of claim 20 implemented by a computer.

25. A computer readable recording medium encoded with the method of claim 21 implemented by a computer.
